(19) United States
(12) Patent Application Publication
(10) Pub. No.: US 2013/0160491 A1
(43) Pub. Date: Jun. 27, 2013

(54) Sunglass with Changeable Charms

(71) Applicant: Candice Hedrick, Santa Barbara, CA (US)

(72) Inventor: Candice Hedrick, Santa Barbara, CA (US)

(21) Appl. No.: 13/333,201

(22) Filed: Dec. 21, 2011

(51) Int. Cl. A44C 25/00; B23P 11/00

(52) U.S. Cl. 63/40; 29/428

(57) ABSTRACT

The present invention is a charm attached to a front surface of a pair of sunglasses, the pair of sunglasses comprising at least one recessed area positioned to the front surface of the pair of sunglasses for securing the charm. A locking means is positioned inside the at least one recessed area to firmly hold the charm in position. The charms can be interchangeably used according to the need of a user. The charm comprises a front surface having an ornamental design and a rear surface designed to fit to the at least one recessed area. The charm can be made from materials of group consisting of metals, paper, plastics, polymers and non-magnetic materials. Children prefer to wear sunglass with charms as it brings their own style to personalize the sunglass. The sunglass provides protection from UVA rays and UVB rays.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This embodiment relates to sunglasses, and more particularly to sunglasses with interchangeable charms that can be firmly secured to the pair of sunglasses.

### DISCUSSION OF RELATED ART

Sunglasses serve as a protective eyewear to prevent bright sunlight and UV rays from damaging or discomforting the eyes and to provide a cooling effect to the eyes. People of different age groups prefer to use sunglasses as a fashion accessory. Children like to wear sunglasses having different color frames that match their dress. Also they feel good in bringing style by adding different small charms to the sunglass. Sunglasses with charms attract children to wear sunglasses thereby providing protection and style to the users.

U.S. Pat. No. 7,914,143 issued to Heim on Mar. 29, 2011 discloses glasses adaptable for interchangeably attaching and securing a variety of charms such that the plane of the backside of the charm is flush against a convex or smooth outwardly facing surface on a pair of glasses. The glasses comprise a depressed region further comprising a planar magnetic base surrounded on all sides by walls substantially perpendicular thereto. Each charm in the present invention has a second magnet adapted for tight fitment into said depressed region, so as to be held in place by magnetic attraction when brought into close proximity with the depressed region. However, the glasses described herein utilize magnetic system for fixing the snaps.

Similarly, U.S. Pat. No. 7,524,052 issued to Esses on Apr. 28, 2009 describes an ornamental eyewear with detachably mounted interchangeable ornaments mounted to at least one of the temple arms of an eyeglass frame. The eyeglass frame includes a pair of temple arms, wherein each of the temple arms includes a temple arm wall. The temple arms include at least one hole opening within at least one of the temple arm walls of one of the temple arms for detachably mounting an ornament therein. The ornament includes a front wall surface in the form of an ornamental shape and includes a rear wall surface with a protrusion member on the rear wall surface of the ornament for detachably mounting and snap-fitting the ornament within the hole opening within the temple arm wall of the temple arm of the eyeglass frame. The protrusion member is in the form of a geometrically-shaped or non-geometrically-shaped protrusion member for detachably mounting and inserting within a geometrically-shaped or non-geometrically-shaped hole opening within one of the temple arm walls. However, ornaments can be fixed only to the temple arms of the sunglass

U. S. Pat. App. No. 20080170198 published to Resler on Jul. 17, 2008 describes a sunglass which includes a frame portion having opposing inner and outer faces, opposed first and second sides, a nose bridge formed between the opposed first and second sides, and a lens opening between the nose bridge and each of the first and second sides. A lens has an outer face applied to the inner face of the frame portion and an opposing inner face, and a side in juxtaposition to each of the first and second sides of the frame portion. Fasteners affix the lens to the frame portion, and first and second temples extend rearwardly of the frame portion at the first and second sides of the frame portion, respectively. However, charms cannot be fixed on to the sunglass frames.

Therefore, there is a need for a sunglass that could be used by the children for bringing their own style. Further, the sunglass would be capable of securely attaching different charms on the frames. Moreover, the charms would be interchangeable and would allow the user to conveniently snap on and snap off the charms. The present invention accomplishes these objectives.

### SUMMARY OF THE INVENTION

The present invention is a charm attached to a front surface of a pair of sunglasses, the pair of sunglasses comprising at least one recessed area positioned to the front surface of the pair of sunglasses for securing the charm. A locking means is positioned inside the recessed area to firmly hold the charm in position. The charm can be interchangeably used according to the need of a user. The charm comprises a front surface having an ornamental design and a rear surface designed to fit to the at least one recessed area. The charm can be made from the materials of group consisting of metals, paper, plastics, polymers and non-magnetic materials. The method of securing the charm to the at least one recessed area positioned at the front surface of the pair of sunglasses includes press fit and glue fit. The charm can also be secured to at least one temple arm of the pair of sunglasses. Children prefer to wear the pair of sunglasses with charm as it brings their own style to personalize the pair of sunglasses. The pair of sunglasses provides protection from UVA rays and UVB rays. Thus, the use of sunglasses with interchangeable charm provides both fun and function to the user.

### DESCRIPTION OF THE DRAWINGS

FIGS. 1A and 1B show front perspective views of a pair of sunglasses showing different varieties of charms fixed onto the front surface;

FIG. 2A shows a side view of a single sunglass showing a recessed area;

FIG. 2B shows a front view of a charm;

FIG. 2C shows a rear view of the charm;

FIG. 2D shows the front view of the charm having a themed character (for instance a penguin);

FIG. 2E shows the rear view of the charm having the themed character (for instance a penguin);

FIG. 2F shows the charm and a recessed area separately;

FIG. 2G shows a way of inserting a charm to the recessed area; and

FIG. 3 shows a flow chart illustrating a method for ornating a front surface of a pair of sunglasses frame.

### DETAILED DESCRIPTION OF THE PREFERRED EMBODIMENT

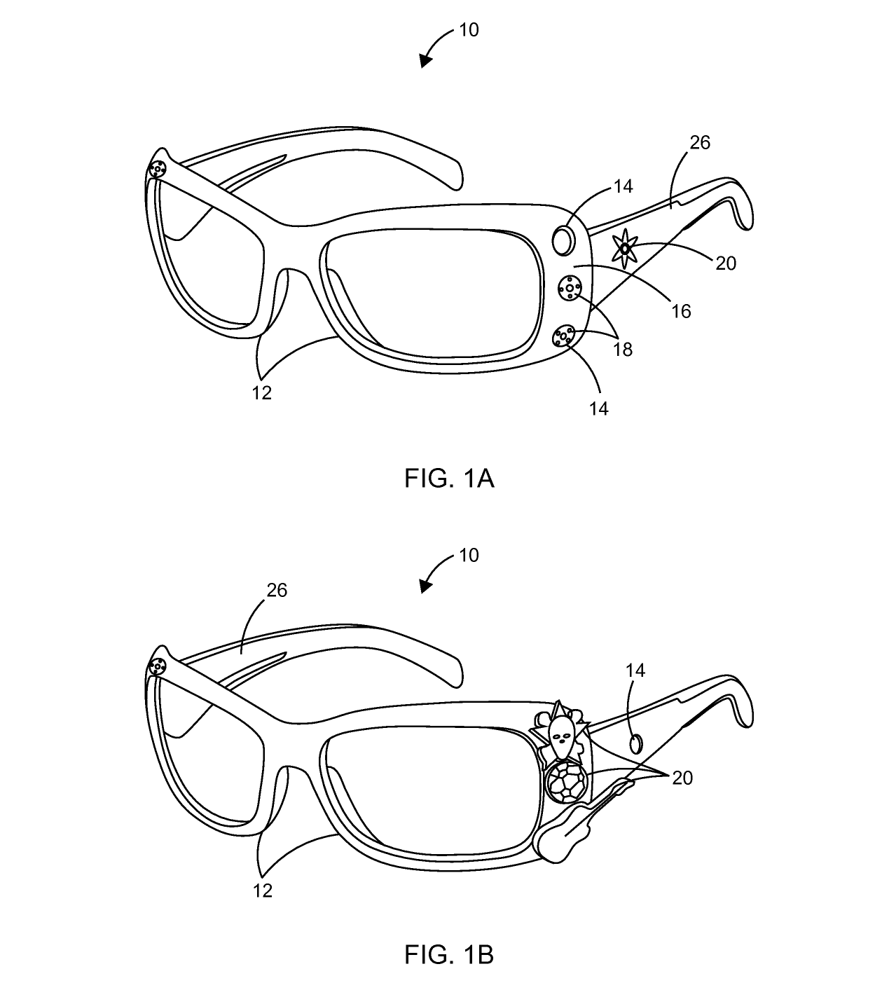

FIGS. 1A and 1B show front perspective views of a pair of sunglasses showing different type of charms fixed onto a front surface 10. The pair of sunglasses 12 comprising at least one recessed area 14 positioned to the front surface 16 of the pair of sunglasses 12 for securing the charm 20. The charm 20 can also be secured to at least one temple arm 26 of the pair of sunglasses 12. A locking means 18 is positioned inside the at least one recessed area 14 to firmly hold the charm 20 in position.

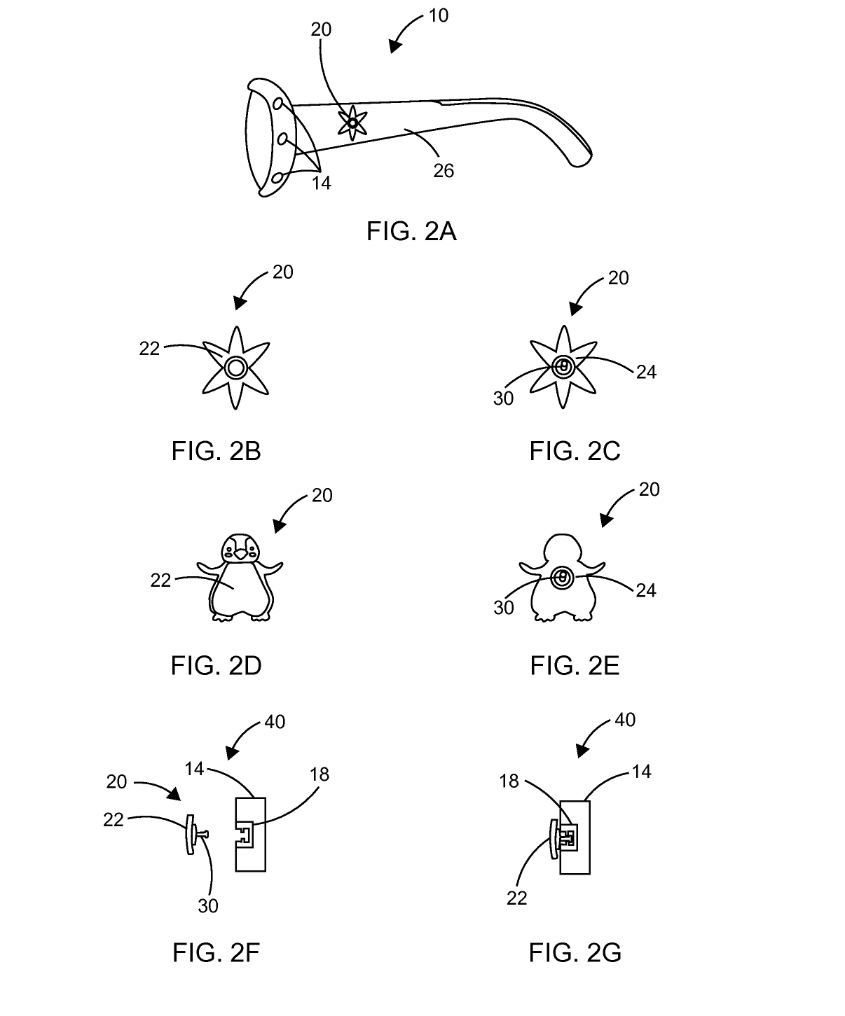

FIG. 2A shows a side view of a single sunglass showing the at least one recessed area 10. The recessed area 14 includes a locking means 18 to firmly hold the charm 20 to the at least one recessed area 14. The charms 20 can be interchangeably used according to the need of a user.

FIG. 2B shows a front view and FIG. 2C shows a rear view of a charm. The charm 20 comprises the front surface 22 having an ornamental design and a rear surface designed 24 to fit to the at least one recessed area 14. The rear surface 24 of the charm can be inserted to the at least one recessed area 14. The charms 20 can be secured to at least one temple arm (not shown) of the pair of sunglasses frame. FIG. 2D shows the front view and FIG. 2E shows the rear view of the charm having penguin as a themed character. The charm can be made from materials of group consisting of metals, paper, plastics, polymers and non-magnetic materials.

In an alternative embodiment of the said invention, the locking means 18 may consists of Velcro. The rear surface 24 of the charm may include a Velcro layer to be attached to a second Velcro layer that is connected to the pair of sunglasses instead of the recessed area 14.

In a further embodiment of the said invention, the exterior of male insert 30 and the recessed area 14 includes threads such that the male insert 30 may be screwed into the receiving portion of the recessed area 14.

FIG. 2F shows the charm and a recessed area separately and FIG. 2G shows the way of attaching the rear surface of the charm to the recessed area 30. The charm 20 comprising the front surface 22 having an ornamental design and a rear surface 24 designed to fit to the at least one recessed area 14. The rear surface 24 of the charm 20 can be inserted into the locking means 18 positioned inside the at least one recessed area 14 to firmly hold the charm 20 in position.

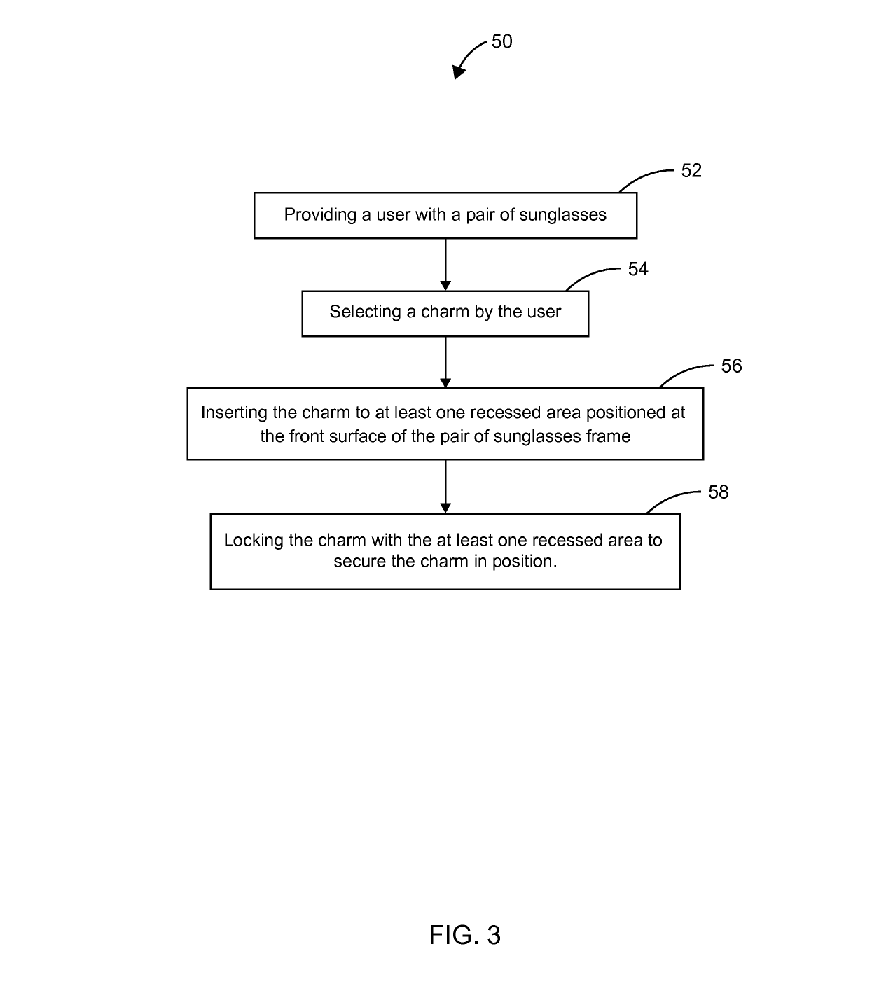

FIG. 3 shows a flow chart illustrating a method for ornating a front surface of a pair of sunglasses 50. The method is initiated by providing a user with a pair of sunglasses as shown in block 52. Then a charm is selected by the user as indicated at block 54. Thereafter, the charm is inserted to at least one recessed area positioned at the front surface of the pair of sunglasses as shown by block 56. Finally the charm is locked with the at least one recessed area to secure the charm in position as shown in block 58.

What is claimed is:

1: A charm attached to a front surface of a pair of sunglasses, the pair of sunglasses comprising:
at least one recessed area positioned to the front surface of the pair of sunglass for securing the at last one charm comprising a front surface having an ornamental design and a rear surface designed to fit to the at least one recessed area, a locking means is positioned inside the at least one recessed area to firmly hold the charm in position.

2: The system of claim 1, wherein the charm can be made from materials of group consisting of metals, paper, plastics, polymers and non-magnetic materials.

3: A method for ornating a front surface of a pair of sunglasses, the method comprising the steps of:
a) providing a user with a pair of sunglasses;
b) selecting a charm by the user;
c) inserting the charm to at least one recessed area positioned at the front surface of the pair of sunglasses frame; and
d) locking the charm with the at least one recessed area to secure the charm in position.

4: The method of claim 3 wherein the charm can be made from a wide variety of materials.

5: The method of claim 4 wherein the charm can be made from materials of group consisting of metals, paper, plastics, polymers and non-magnetic materials.

6: The system of claim 1, wherein the rear surface design includes a male insert with threads to be screwed into the at least one recessed area.
